(19) United States
(12) Patent Application Publication
(10) Pub. No.: US 2025/0321431 A1
(43) Pub. Date: Oct. 16, 2025

(54) OPTICAL COMBINER AND OPTICAL DEVICE USING THE SAME

(71) Applicant: HTC Corporation, Taoyuan City (TW)

(72) Inventor: Qing-Long DENG, Taoyuan City (TW)

(21) Appl. No.: 19/176,182

(22) Filed: Apr. 11, 2025

Related U.S. Application Data
(60) Provisional application No. 63/632,531, filed on Apr. 11, 2024.

(51) Int. Cl. G02B 27/10; G02B 27/01

(52) U.S. Cl. CPC G02B 27/1006; G02B 27/0172; G02B 2027/0112; G02B 2027/0178

(57) ABSTRACT

An optical device includes an image projector and an optical combiner. The image projector is configured to emit image light. The optical combiner is disposed in an optical path of the image light. The optical combiner includes a colorant element. The colorant element is configured to absorb light within at least one specific wavelength range.

### CROSS-REFERENCE TO RELATED APPLICATION

This application claims priority to U.S. Provisional Application Ser. No. 63/632,531, filed on Apr. 11, 2024, which is herein incorporated by reference.

### BACKGROUND

### Technical Field

The present disclosure relates to an optical combiner and an optical device using the same.

### Description of Related Art

The current state of augmented reality (AR) devices involves various optical elements such as reflective mirrors and lenses, which are generally colorless and transparent, thus having minimal impact on the color of the original image source, aside from inherent component light loss. However, in AR devices utilizing waveguide elements, the inherent wavelength and angular selectivity of these waveguides introduces challenges in color reproduction. Specifically, when an input image passes through the waveguide, different wavelengths of light are diffracted at varying angles and with different efficiencies due to the diffraction/holographic structures. Theoretically, shorter wavelengths like blue light are diffracted at smaller angles, while longer wavelengths like red light are diffracted at larger angles. This difference in diffraction angles and efficiencies across the color spectrum, even with narrow-bandwidth single-color light sources, results in uneven brightness distribution and color dispersion (color fringing). Consequently, when displaying a white image on a waveguide-based AR device, a gradient rainbow-like color shift with non-uniform brightness is readily observable, typically transitioning from blue to red from one side of the viewing area to the other.

A common conventional approach to mitigate this issue involves adjusting the energy ratios of the red, green, and blue light sources in the image projector to compensate for the different diffraction efficiencies and approximate a mixed white light. For instance, if the initial white light energy ratio of red, green, and blue is 3:6:1, and the peak diffraction efficiencies are 3%, 8%, and 2% respectively, the light source might be adjusted to a ratio of 2:1.5:1 to maintain a white light energy balance after diffraction. However, this approach is fundamentally limited by the least efficient color component (e.g., blue light in the given example), forcing the other colors to be adjusted proportionally, thus leading to a significant reduction in the overall brightness of the final displayed image. Moreover, AR devices commonly employ high-transmittance optical elements, including waveguides, which allow ambient light from the real-world environment to pass through to the user's eyes. This ambient light can be superimposed with the colors of the AR image, causing color distortions. For example, using an AR device in a yellow-lit environment can cause the AR image to appear yellowish. Traditional color correction methods that only focus on adjusting the virtual image light source often neglect or are significantly affected by this ambient light, limiting their effectiveness in achieving accurate and uniform color perception.

Accordingly, it is an important issue for the industry to provide an optical combiner and an optical device using the same that are capable of solving the aforementioned problems.

### SUMMARY

An aspect of the disclosure is to provide an optical combiner and an optical device using the same that can efficiently solve the aforementioned problems.

According to an embodiment of the disclosure, an optical combiner includes a light-transmitting substrate and a colorant element. The colorant element is connected to the light-transmitting substrate and is configured to absorb light within at least one specific wavelength range.

In an embodiment of the disclosure, the colorant element includes a transition metal element or a rare earth metal element doped in the light-transmitting substrate.

In an embodiment of the disclosure, the colorant element includes colloid particles mixed in the light-transmitting substrate.

In an embodiment of the disclosure, the colorant element includes colorant molecules mixed in the light-transmitting substrate. The colorant molecules include Tin oxide.

In an embodiment of the disclosure, the colorant element includes a reflective film coated on a surface of the light-transmitting substrate.

In an embodiment of the disclosure, the colorant element includes a gradient colorant gradually transformed from a first colorant to a second colorant substantially in a direction parallel to a surface of the light-transmitting substrate.

According to an embodiment of the disclosure, an optical device includes an image projector and an optical combiner. The image projector is configured to emit image light. The optical combiner is disposed in an optical path of the image light. The optical combiner includes a colorant element. The colorant element is configured to absorb light within at least one specific wavelength range.

In an embodiment of the disclosure, the optical combiner further includes a light-transmitting substrate. The colorant element includes a transition metal element or a rare earth metal element doped in the light-transmitting substrate.

In an embodiment of the disclosure, the optical combiner further includes a light-transmitting substrate. The colorant element includes colloid particles mixed in the light-transmitting substrate.

In an embodiment of the disclosure, the optical combiner further includes a light-transmitting substrate. The colorant element includes colorant molecules mixed in the light-transmitting substrate. The colorant molecules include Tin oxide.

In an embodiment of the disclosure, the optical combiner further includes a light-transmitting substrate. The colorant element includes a reflective film coated on the light-transmitting substrate.

In an embodiment of the disclosure, the light-transmitting substrate has a surface. The reflective film is coated on the surface. The image light is incident on the reflective film.

In an embodiment of the disclosure, the light-transmitting substrate has a first surface and a second surface opposite to each other. The image light is emitted toward the first surface. The reflective film is coated on the second surface.

In an embodiment of the disclosure, the optical combiner further includes a light-transmitting substrate. The colorant element includes a gradient colorant gradually transformed from a first colorant to a second colorant substantially in a direction parallel to a surface of the light-transmitting substrate.

In an embodiment of the disclosure, the direction is substantially away from the image projector. The first colorant is reddish. The second colorant is bluish.

Accordingly, in the optical combiner and the optical device of the present disclosure, the colorant element configured to absorb light within at least one specific wavelength range is provided on or mixed in the light-transmitting substrate of the optical combiner. By absorbing or reflecting the light within the at least one specific wavelength range, the color of light passing through the optical combiner can be adjusted, so as to achieve color absorbing and balancing effects. By employing the colorant element including a gradient colorant gradually transforms from a first colorant to a second colorant substantially in a direction parallel to a surface of the light-transmitting substrate, different color absorbing or adjustment effects can be realized in different regions of the optical combiner. In other words, the present disclosure employs the optical combiner including the colorant element that utilizes a subtractive color mixing approach, thereby not only enabling simultaneous color correction for both virtual and real-world images but also facilitating color correction across different regions. Consequently, the present disclosure effectively addresses issues such as color distortion in virtual images, poor white balance, and challenges in blending real-world ambient light encountered in conventional optical devices, thereby enhancing the visual quality and immersion for users within the augmented reality experience.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic view of an optical device according to an embodiment of the present disclosure;

FIG. 2 is a schematic diagram of an optical combiner in FIG. 1;

FIG. 3 is a schematic diagram of subtractive color mixing;

FIG. 4 is a partial cross-sectional view of the optical combiner according to another embodiment of the present disclosure;

FIG. 5 is a schematic view of an optical device according to another embodiment of the present disclosure;

FIG. 6 is a schematic diagram of an optical combiner in FIG. 5;

FIG. 7 is a partial schematic view of the optical combiner in FIG. 2;

FIG. 8 is a partial schematic view of an optical combiner according to another embodiment of the present disclosure; and

FIG. 9 is a partial schematic view of an optical combiner according to another embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts. However, specific structural and functional details disclosed herein are merely representative for purposes of describing example embodiments, and thus may be embodied in many alternate forms and should not be construed as limited to only example embodiments set forth herein. Therefore, it should be understood that there is no intent to limit example embodiments to the particular forms disclosed, but on the contrary, example embodiments are to cover all modifications, equivalents, and alternatives falling within the scope of the disclosure.

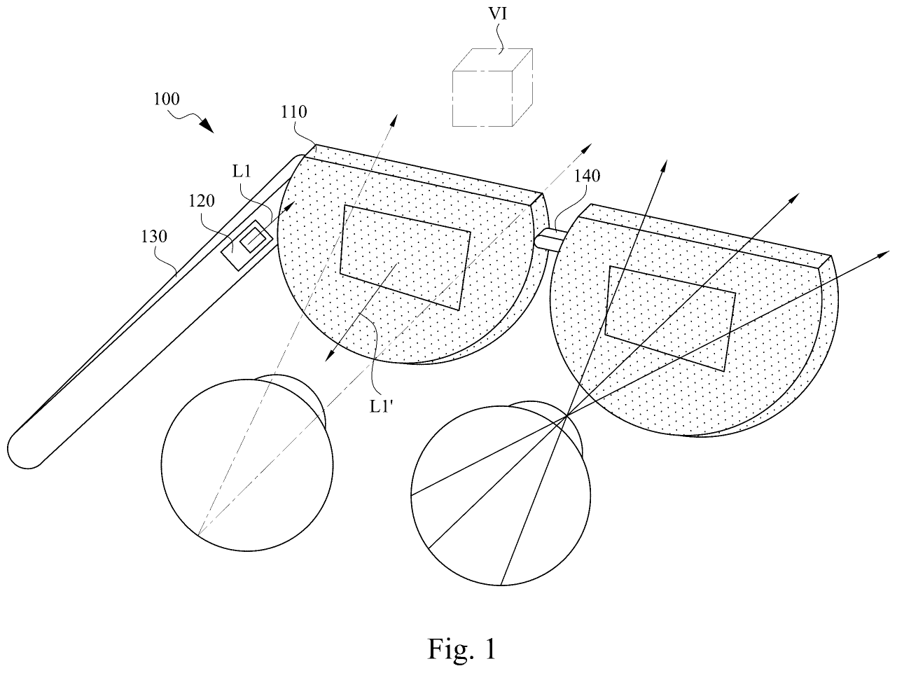

Reference is made to FIG. 1. FIG. 1 is a schematic view of an optical device 100 according to an embodiment of the present disclosure. As shown in FIG. 1, in the present embodiment, the optical device 100 may be used in an augmented reality device which can be implemented as, but is not limited thereto, a pair of glasses or other wearable display devices. Specifically, the optical device 100 includes two optical combiners 110, an image projector 120, a temple 130, and a connecting member 140. The connecting member 140 is connected between the optical combiners 110. The temple 130 is connected to an edge of one of the optical combiners 110. The image projector 120 is disposed on a side of the temple 130 adjacent to the one of optical combiners 110. The optical device 100 may include another temple 130 (not shown) connected to an edge of another of the optical combiners 110. The primary function of each of the optical combiners 110 is to superimpose a virtual image VI generated by the image projector 120 onto the real world scene viewed through the optical combiner 110 by the user.

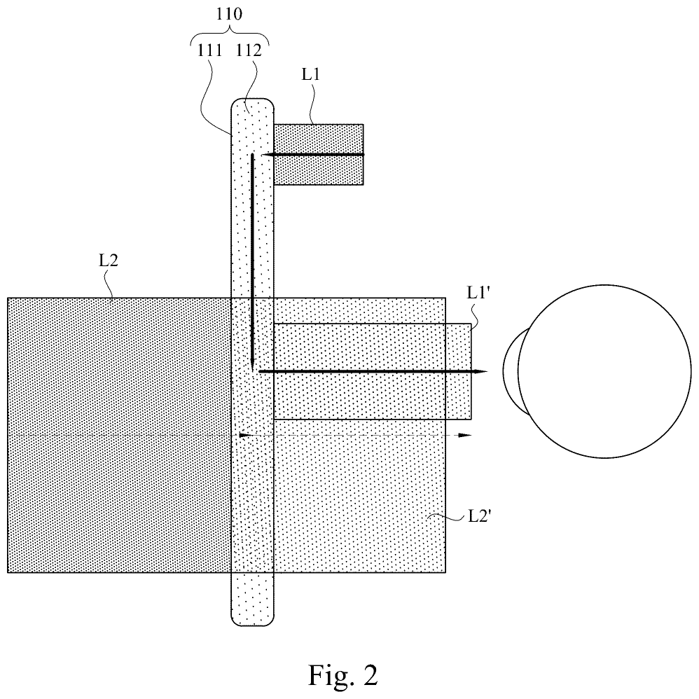

Reference is made to FIG. 2. FIG. 2 is a schematic diagram of the optical combiner 110 in FIG. 1. As shown in FIG. 2 with reference to FIG. 1, in the present embodiment, the image projector 120 is configured to emit image light L1 toward the optical combiner 110. The optical combiner 110 is disposed in an optical path of the image light L1. The optical combiner 110 includes a light-transmitting substrate 111 and a colorant element 112. The colorant element 112 is connected to the light-transmitting substrate 111 and is configured to absorb light within at least one specific wavelength range. Specifically, in the present embodiment, the colorant element 112 is configured to absorb the light within the at least one specific wavelength range. In this way, the image light L1 entering and propagating in the optical combiner 110 will be output as image light L1′, and ambient light L2 will be output as ambient light L2′ after propagating through the optical combiner 110.

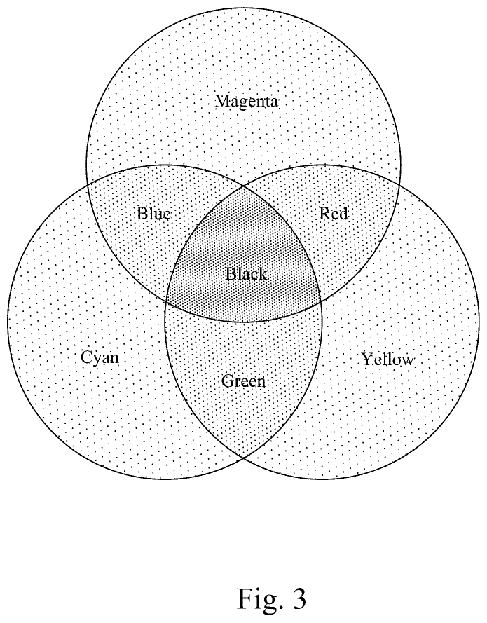

Reference is made to FIG. 3. FIG. 3 is a schematic diagram of subtractive color mixing. As shown in FIG. 3, subtractive color mixing, also known as CMY mixing, is commonly used in printing or dyeing applications. Its basic principle lies in the property of colorants to absorb specific wavelengths of light. As shown in FIG. 3, Magenta, Cyan, and Yellow are the three primary colors of subtractive mixing. When these three primary colors are mixed, they tend towards black.

Magenta and Yellow mix to form Red, Yellow and Cyan mix to form Green, and Cyan and Magenta mix to form Blue. This is in direct contrast to the principle of additive color mixing (RGB mixing), which is the mixing of light, where Red, Green, and Blue mix to form white. The present disclosure applies the concept of subtractive color mixing to the optical device 100 by adding colorants to the optical combiners 110, allowing them to absorb specific light wavelengths, thereby achieving color correction.

In typical augmented reality devices, regardless of whether the color light source of the image unit is from LED, Laser, LEDoS, or OLEDoS, the color mixing theory is additive color mixing, for example, [λ_{R}⁽²⁵⁵⁾+λ_{G}⁽²⁵⁵⁾+λ_{B}⁽²⁵⁵⁾] enables the image to ultimately display a white screen. Similarly, because augmented reality devices can directly see through the environmental scenes of the real world, natural light or artificial ambient light is also transmitted to the human eye through additive color mixing methodology. From this discussion, it can be found that the augmented reality devices must simultaneously satisfy the transmission of virtual images and real-world environmental scenes, so they are often described by a light intensity formula and an image intensity contrast formulas respectively:

$${I}_{vision} = {I}_{virtual image} + {I}_{real world scene} \qquad ( 1 )$$

$$Contrast ratio = {I}_{virtual image} / ( {I}_{virtual image} + {I}_{real world scene} ) \qquad ( 2 )$$

where Iᵥᵢₛᵢₒₙ is the total light intensity, I_{virtual image} is the light intensity of the virtual image, and I_{real world scene} is the light intensity of the real world scene.

In this disclosure, the light intensity is further subdivided into visible color light intensities I_{λ}, such as I_{red}, I_{green}, and I_{blue}, where red is the wavelength of about 620 nm to about 750 nm, green is the wavelength of about 495 nm to about 570 nm, and blue is the wavelength of about 450 nm to about 475 nm. Since the visible light wavelength is about 380 nm to about 750 nm, this disclosure is not limited to three segments of color light intensity. After applying the above visible color light intensities to the virtual image and the real world scene, the intensity distribution of each color light can be analyzed separately.

Next, the subtractive color mixing method is introduced into the optical device 100. For example, the optical combiner 110 with a magenta colorant element 112 can absorb green light in the image light L1 and also absorb green light in the ambient light L2 that pass through the optical combiner 110. The optical combiner 110 with a yellow colorant element 112 can absorb blue light in the image light L1 and also absorb blue light in the ambient light L2 that pass through the optical combiner 110.

In order to maintain the light transmittance of the optical combiner 110, the absorption rate of the magenta colorant for the green wavelength may be adjusted to about 10% to 20%, but the disclosure is not limited thereto. As a result, the light intensity formulas may be modified as follows:

$${I}_{{λ}^{*} ( virtual image )} = {I}_{λ ( virtual image )} - [ {I}_{λ ( combiner )} \times {λ}_{absorption ( \% )} ] \qquad ( 3 )$$

$${I}_{{λ}^{*} ( real world scene )} = {I}_{λ ( real world scene )} - [ {I}_{λ ( combiner )} \times {λ}_{absorption ( \% )} ] \qquad ( 4 )$$

$${I}_{vision} = {I}_{virtual image} + {I}_{real world scene} \qquad ( 5 )$$

In some embodiments, the colorant element 112 includes a transition metal element or a rare earth metal element doped in the light-transmitting substrate 111. The rare earth metal element may be one of the lanthanide series, scandium (Sc), and yttrium (Y). Based on the unique properties of the elements used, these doping elements can selectively absorb light within specific wavelength ranges, allowing the unabsorbed wavelengths to pass through, thereby presenting a transparent optical element with a specific color tint.

The advantage of the present embodiment is the introduction of color absorbing properties within the material essence of the light-transmitting substrate 111, without the need for additional coatings or other structures. When the image light L1 from the optical device 100 or the ambient light L2 from the real world passes through the light-transmitting substrate 111 doped with a transition metal element or a rare earth metal element, light of specific wavelengths will be absorbed, thereby achieving color correction and balancing effects. The optical combiner 110 helps to improve the problem of uneven color distribution caused by the wavelength selectivity and angular selectivity of waveguide elements, such as the rainbow-like color shift produced when displaying a white image. By selecting appropriate doping elements and their concentrations, the absorption spectrum of the optical combiner 110 can be precisely adjusted, thereby attenuating specific wavelengths of colored light to enhance the color saturation of the overall image and more effectively blend the colors of the virtual image VI with the real world scene.

In some embodiments, a material of the light-transmitting substrate 111 includes glass, but the disclosure is not limited thereto.

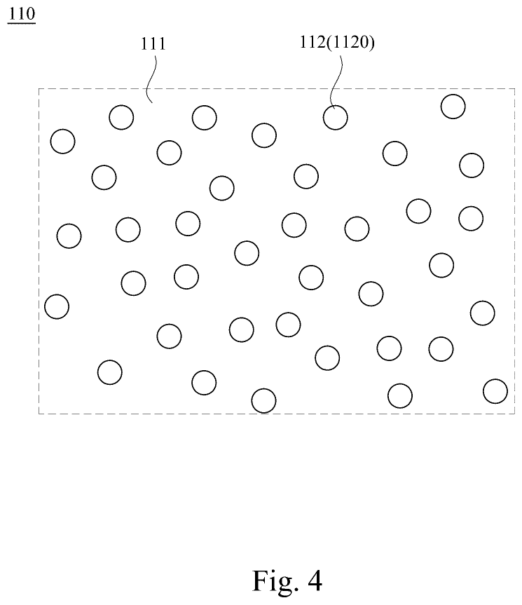

Reference is made to FIG. 4. FIG. 4 is a partial cross-sectional view of the optical combiner 110 according to another embodiment of the present disclosure. As shown in FIG. 4, in the present embodiment, the colorant element 112 includes colloid particles 1120 mixed in the light-transmitting substrate 111. These colloid particles 1120 may have the characteristics of absorbing or scattering light of specific wavelengths, or they may be further combined with colored substances (such as colorant molecules) to collectively exhibit specific light absorbing effects. These colloid particles 1120 may exhibit scattering effects on light of specific wavelengths due to their physical properties (such as Rayleigh scattering when the size is much smaller than the wavelength of light, or Mie scattering when the size is close to the wavelength of light), resulting in a reduction in the transmittance of light within that wavelength range, thereby achieving the purpose of light absorbing. In other words, the dispersion of the colloid particles 1120 in the light-transmitting substrate 111 can be uniform to achieve a uniform color absorbing effect for the entire optical combiner 110.

Integrating the colorant element 112 containing the colloid particles 1120 into the optical combiner 110 of the optical device 100 can effectively perform color correction for the virtual image VI and real-world images. By selecting appropriate types, sizes, shapes, and concentrations of colloid particles 1120, the color balance of light passing through the optical combiner 110 can be precisely adjusted, improving the problems of chromatic dispersion and color unevenness caused by the wavelength selectivity and angular selectivity of waveguide elements in the conventional technology. In addition, the present embodiment can also simultaneously affect the ambient light L2 passing through the optical combiner 110, which helps to enhance the color fusion between the augmented reality image and the real world scene.

In some embodiments, the colorant element 112 includes molecules mixed in the light-transmitting substrate 111. The colorant molecules include Tin oxide. By uniformly dispersing the colorant molecules within the light-transmitting substrate 111, the optical combiner 110 can inherently possess the ability to selectively absorb light within specific wavelength ranges.

The colorant element 112 formed by the colorant molecules has the advantage of achieving precise color absorbing and correction without relying on surface coatings or other additional processes. When the image light L1 emitted from the image projector 120 of the optical device 100 or the ambient light L2 from the real-world environment passes through this light-transmitting substrate 111 mixed with colorant molecules, light of specific wavelengths will be subtractively absorbed, resulting in an adjustment of the color components of the transmitted light. For example, if there is an excess of green light in the image light L1, the colorant molecules capable of absorbing green wavelengths can be selected, thereby reducing the green light component after transmission and improving the overall color balance, bringing it closer to the desired color performance, such as a purer white.

It is noted that due to the characteristics of waveguide elements, different wavelengths of light are diffracted at varying angles during transmission, which can lead to color deviation in different areas of the final virtual image. For example, white light passing through the waveguide may exhibit a rainbow effect with blue light shifted to one side and red light to the other. To correct this uneven color distribution, in some embodiments, the colorant element 112 may include a gradient colorant gradually transformed from a first colorant to a second colorant substantially in a direction parallel to a surface of the light-transmitting substrate 111. That is, the colorant element 112 may exhibit a gradient change to achieve a gradient colorant element with different absorbing characteristics in different regions. For example, the light-transmitting substrate 111 with a colloid concentration gradually increasing from one side to the other can be fabricated, so that the degree of absorption or scattering of light passing through different regions is different, resulting in a gradient color effect.

In detail, since the blue light in the image light L1 may ultimately be projected in a direction relatively far from the image projector 120, the bluish second colorant in that area can further absorb excess red and green light, thereby enhancing the performance of blue light and bringing it closer to the target color. Conversely, in the direction close to the image projector 120, the reddish first colorant can absorb excess blue and green light, compensating for the deficiency of red light. Through this region-specific color adjustment, the color of the virtual image VI ultimately viewed by the user can be made more uniform, improving white balance and overall color saturation.

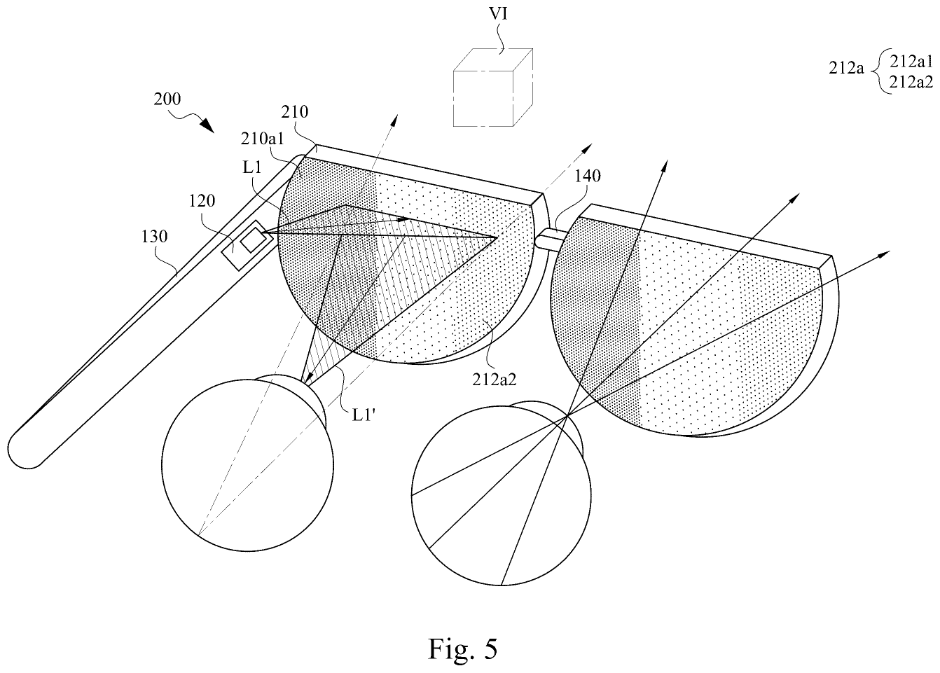

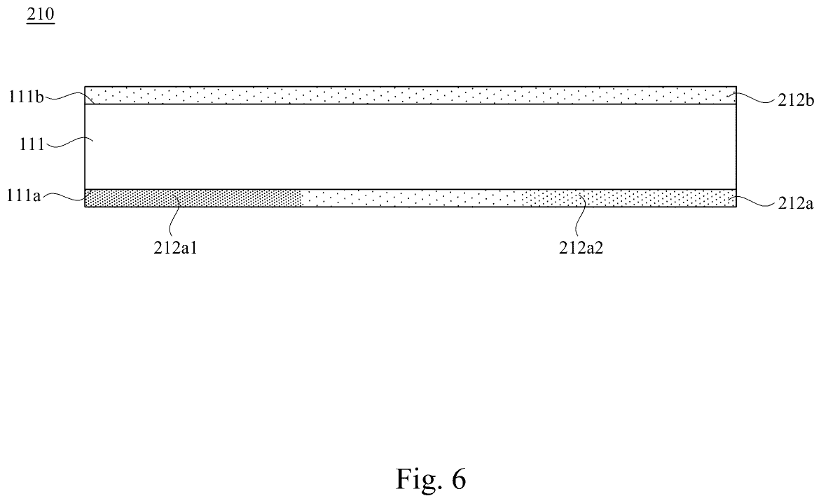

Reference is made to FIG. 5 and FIG. 6. FIG. 5 is a schematic view of an optical device 200 according to another embodiment of the present disclosure. FIG. 6 is a schematic diagram of an optical combiner 210 in FIG. 5. As shown in FIG. 5 and FIG. 6, in the present embodiment, the optical device 200 includes two optical combiners 210, an image projector 120, a temple 130, and a connecting member 140, in which the image projector 120, the temple 130, and the connecting member 140 are identical to those of the embodiment shown in FIG. 1. Therefore, the relevant descriptions of these components can be found in the previous paragraphs and will not be repeated here for simplicity.

As shown in FIG. 6 with reference to FIG. 5, the optical combiner 210 includes a light-transmitting substrate 111 and a colorant element. The colorant element includes a reflective film 212a. The light-transmitting substrate 111 has a first surface 111a and a second surface 111b opposite to each other. For example, the first surface 111a faces the user's eye and the second surface 111b faces the outside world. The reflective film 212a is coated on the first surface 111a. In other words, the image light L1 is incident on the reflective film 212a. When the image light L1 emitted from the image projector 120 directly strikes the reflective film 212a coated on the first surface 111a, the reflective film 212a will reflect the image light L1′ to the user's eye and absorb light of specific wavelengths according to its designed spectral absorbing characteristics. For example, the absorption rate of the reflective film 212a for the specific wavelengths may be about 10% to about 20%, but the disclosure is not limited thereto. By precisely controlling the material composition, thickness, and structure of the reflective film 212a, its absorption spectrum can be customized, thereby adjusting the color balance of the reflected light and reducing issues such as color dispersion.

Furthermore, since the image light L1 is directly incident on the reflective film 212a, the absorption mainly affects the virtual image VI from the optical device 100. However, the ambient light L2 from the real world will also be affected by this reflective film 212a when passing through the light-transmitting substrate 111. If the ambient light L2 contains an excessive amount of specific wavelength components, the reflective film 212a will also partially absorb them, thereby helping to regulate the color of the ambient light L2′ entering the user's eye, further enhancing the color fusion between the virtual image VI and the real world scene.

As shown in FIG. 6, in the present embodiment, the colorant element further includes a reflective film 212b. The reflective film 212b is coated on the second surface 111b of the light-transmitting substrate 111. The reflective film 212b can further adjust the light passing through the light-transmitting substrate 111, for example, by absorbing specific wavelengths. Specifically, when the ambient light L2 from the external environment is incident on the optical device 100, the function of the reflective film 212b is to absorb at least a portion of the ambient light L2 within a specific wavelength range. By absorbing specific wavelengths of the ambient light L2, the reflective film 212b can effectively reduce ambient stray light entering the user's eye, thereby improving the contrast between the virtual image VI and the real world scene. For instance, if there is an excessive amount of specific colored light in the ambient light L2, it may affect the user's perception of the colors of the virtual image VI, and the reflective film 212b can absorb these interfering colored lights.

As shown in FIG. 6 with reference to FIG. 5, in the present embodiment, the reflective film 212a of the colorant element includes a gradient colorant that exhibits a gradual change in color substantially along a direction parallel to a surface (e.g., the first surface 111a or the second surface 111b) of the light-transmitting substrate 111. Specifically, the color of the reflective film 212a transitions from a reddish hue at the first colorant 212a1 near the image projector 120, and gradually transforms towards a bluish hue at the second colorant 212a2 in the direction substantially away from the image projector 120. This color gradient is designed to compensate for the color dispersion (such as blue light being diffracted towards one side and red light towards the other) that occurs due to different wavelengths.

In detail, since the red light in the image light L1 may ultimately be projected in a direction relatively far from the image projector 120, the bluish second colorant 212a2 in that area can further absorb or reflect excess red and green light, thereby enhancing the performance of blue light and bringing it closer to the target color. Conversely, in the direction close to the image projector 120, the reddish first colorant 212a1 can absorb or reflect excess blue and green light, compensating for the deficiency of red light. Through this region-specific color adjustment, the color of the virtual image VI ultimately viewed by the user can be made more uniform, improving white balance and overall color saturation.

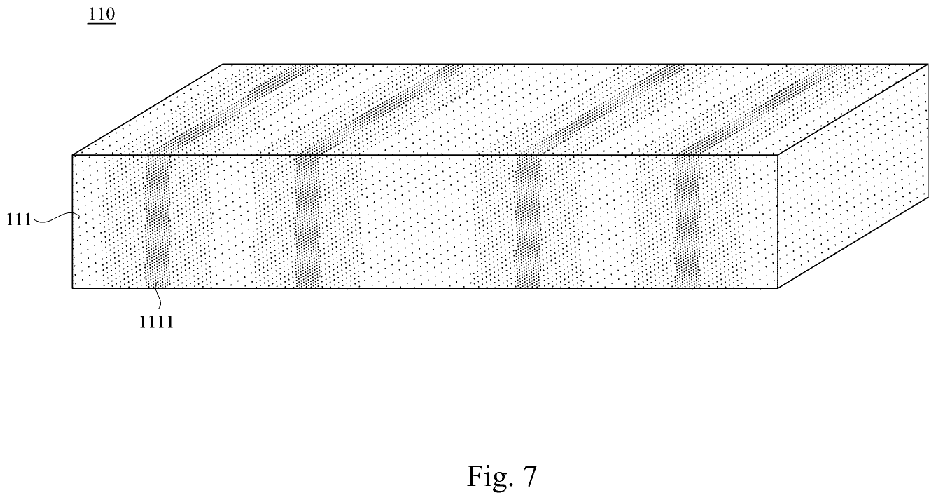

Reference is made to FIG. 7. FIG. 7 is a partial schematic view of the optical combiner 110 in FIG. 2. As shown in FIG. 7, in the present embodiment, the light-transmitting substrate 111 of the optical combiner 110 includes at least one holographic grating 1111. The holographic grating 1111 is configured to diffract the light incident on the optical combiner 110. The holographic grating 1111 of the optical combiner 110 may be a reflective holographic grating or a transmissive holographic grating. The holographic grating 1111 is a volume holographic grating. It is notable that light diffracted by a volume holographic grating can propagate based on the Bragg's law.

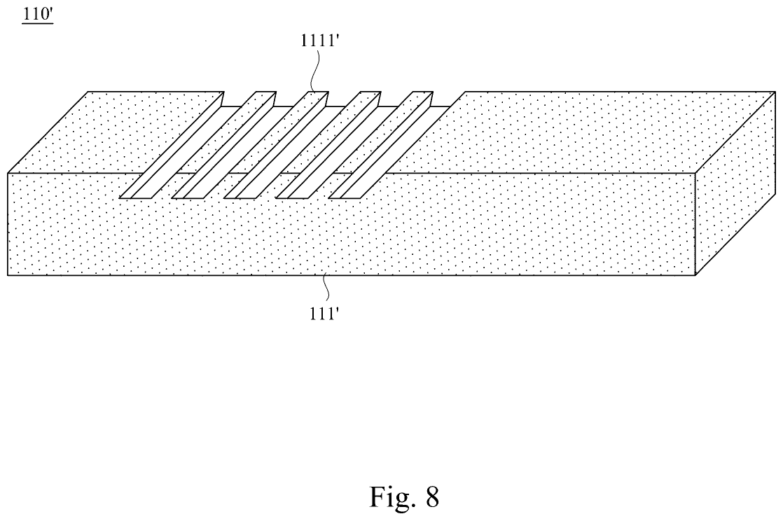

Reference is made to FIG. 8. FIG. 8 is a partial schematic view of an optical combiner 110′ according to another embodiment of the present disclosure. As shown in FIG. 8, in the present embodiment, the light-transmitting substrate 111′ of the optical combiner 110′ includes a plurality of surface structures 1111′. The optical combiner 110′ uses the surface structures 1111′ to form width periodic structures. The surface structures 1111′ may be manufactured to form a surface relief diffraction grating, and the surface relief diffraction grating may form a holographic grating. In this way, the diffraction characteristics of the holographic grating of the optical combiner 110′ formed by the surface relief diffraction grating may be identical or similar to the diffraction characteristics of the holographic grating of the optical combiner 110 formed by the volume holographic grating.

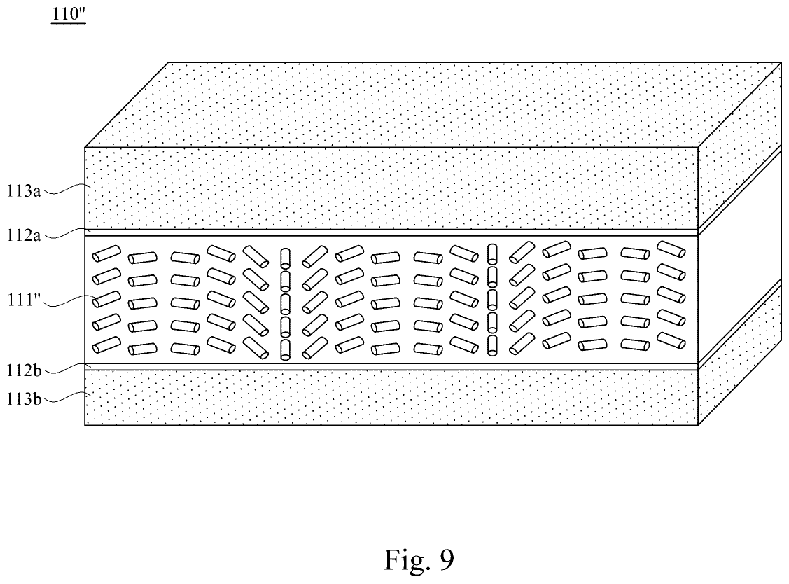

Reference is made to FIG. 9. FIG. 9 is a partial schematic view of an optical combiner according to another embodiment of the present disclosure. As shown in FIG. 9, in the present embodiment, the optical combiner 110″ includes a plurality of liquid crystal molecules 111″ disposed between two photo-alignment layers 112a, 112b, and the photo-alignment layers 112a, 112b are sandwiched between two light-transmitting substrates 113a, 113b. A voltage may be applied to the photo-alignment layers 112a, 112b to rotate the liquid crystal molecules 111″ to form width periodic structures. In other words, the optical combiner 110″ uses the internal liquid crystal molecules 111″ to form width periodic structures, so outer surfaces of the light-transmitting substrates 113a, 113b have no solid structure. The rotated liquid crystal molecules 111″ may form a liquid crystal grating, and the liquid crystal grating may form a holographic grating. In this way, the diffraction characteristics of the holographic grating of the optical combiner 110″ formed by the liquid crystal grating may be identical or similar to the diffraction characteristics of the holographic grating of the optical combiner 110 formed by the volume holographic grating.

In some embodiments, at least one of the optical combiner 110 and the optical combiner 210 may be one of a waveguide element, a reflective lens element, a semi-transparent lens element, and a freeform lens element, but the disclosure is not limited thereto.

According to the foregoing recitations of the embodiments of the disclosure, it can be seen that in the optical combiner and the optical device of the present disclosure, the colorant element configured to absorb light within at least one specific wavelength range is provided on or mixed in the light-transmitting substrate of the optical combiner. By absorbing or reflecting the light within the at least one specific wavelength range, the color of light passing through the optical combiner can be adjusted, so as to achieve color absorbing and balancing effects. By employing the colorant element including a gradient colorant gradually transforms from a first colorant to a second colorant substantially in a direction parallel to a surface of the light-transmitting substrate, different color absorbing or adjustment effects can be realized in different regions of the optical combiner. In other words, the present disclosure employs the optical combiner including the colorant element that utilizes a subtractive color mixing approach, thereby not only enabling simultaneous color correction for both virtual and real-world images but also facilitating color correction across different regions. Consequently, the present disclosure effectively addresses issues such as color distortion in virtual images, poor white balance, and challenges in blending real-world ambient light encountered in conventional optical devices, thereby enhancing the visual quality and immersion for users within the augmented reality experience.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An optical combiner, comprising:
a light-transmitting substrate; and
a colorant element connected to the light-transmitting substrate and configured to absorb light within at least one specific wavelength range.

2. The optical combiner of claim 1, wherein the colorant element comprises a transition metal element or a rare earth metal element doped in the light-transmitting substrate.

3. The optical combiner of claim 1, wherein the colorant element comprises colloid particles mixed in the light-transmitting substrate.

4. The optical combiner of claim 1, wherein the colorant element comprises colorant molecules mixed in the light-transmitting substrate, and the colorant molecules comprise Tin oxide.

5. The optical combiner of claim 1, wherein the colorant element comprises a reflective film coated on a surface of the light-transmitting substrate.

6. The optical combiner of claim 1, wherein the colorant element comprises a gradient colorant gradually transformed from a first colorant to a second colorant substantially in a direction parallel to a surface of the light-transmitting substrate.

7. An optical device, comprising:
an image projector configured to emit image light; and
an optical combiner disposed in an optical path of the image light, wherein the optical combiner comprises a colorant element configured to absorb light within at least one specific wavelength range.

8. The optical device of claim 7, wherein the optical combiner further comprises a light-transmitting substrate, and the colorant element comprises a transition metal element or a rare earth metal element doped in the light-transmitting substrate.

9. The optical device of claim 7, wherein the optical combiner further comprises a light-transmitting substrate, and the colorant element comprises colloid particles mixed in the light-transmitting substrate.

10. The optical device of claim 7, wherein the optical combiner further comprises a light-transmitting substrate, the colorant element comprises colorant molecules mixed in the light-transmitting substrate, and the colorant molecules comprise Tin oxide.

11. The optical device of claim 7, wherein the optical combiner further comprises a light-transmitting substrate, and the colorant element comprises a reflective film coated on the light-transmitting substrate.

12. The optical device of claim 11, wherein the light-transmitting substrate has a surface, the reflective film is coated on the surface, and the image light is incident on the reflective film.

13. The optical device of claim 11, wherein the light-transmitting substrate has a first surface and a second surface opposite to each other, the image light is emitted toward the first surface, and the reflective film is coated on the second surface.

14. The optical device of claim 7, wherein the optical combiner further comprises a light-transmitting substrate, the colorant element comprises a gradient colorant gradually transformed from a first colorant to a second colorant substantially in a direction parallel to a surface of the light-transmitting substrate.

15. The optical device of claim 14, wherein the direction is substantially away from the image projector, the first colorant is reddish, and the second colorant is bluish.
